(19) United States
(12) Patent Application Publication
(10) Pub. No.: US 2013/0117710 A1
(43) Pub. Date: May 9, 2013

(54) System and Method of Viewing Updating for Planning Item Assemblies

(71) Applicants: Wolfgang Walter, Heidelberg (DE); Barbara Freund, Heidelberg (DE)

(72) Inventors: Wolfgang Walter, Heidelberg (DE); Barbara Freund, Heidelberg (DE)

(73) Assignee: SAP AG, Walldorf (DE)

(21) Appl. No.: 13/288,251

(22) Filed: Nov. 3, 2011

(51) Int. Cl. G06F 3/048

(52) U.S. Cl. 715/790

(57) ABSTRACT

A system and method of displaying item lists and item views for a product assembly process. The method includes storing item data and visualization data, displaying the item data, receiving a first user input that selects a subset of the item data, receiving a second user input that selects a viewing mode, and, in response to a third user input, reading a subset of the visualization data that corresponds to the first user input and displaying the subset of the visualization data according to the viewing mode. In this manner, downloading time and display processing time is saved as compared to other systems.

### CROSS REFERENCE TO RELATED APPLICATIONS

Not applicable.

### BACKGROUND

1. Field of the Invention

The present invention relates to work scheduling for an assembly process, and in particular, to graphical processing tools for work scheduling.

2. Description of the Related Art

Unless otherwise indicated herein, the approaches described in this section are not prior art to the claims in this application and are not admitted to be prior art by inclusion in this section.

Assembling a final product from its components is a complex process. One stage in a systematic process for performing the assembly is for a work scheduler (the user of a work scheduling system) to generate a routing. The routing describes how to assemble the various components into the final product.

In fact, generating the routing is itself a complex process. Often the work scheduler will be provided with an engineering drawing (e.g., managed by a computer aided design (CAD) system) and a component list (e.g., managed by an inventory system); the work scheduler then uses engineering knowledge to define tasks that describe how to assemble the various components in a certain order and to assign the tasks to qualified personnel to perform the assembly.

### SUMMARY

Given the above background, there is a need to improve the work scheduling process. One area of improvement is to link the component list and the engineering drawing. An embodiment of the present invention is directed toward a graphical environment that coordinates the display of component lists and the display of visualizations of the components, in order to facilitate generation of the routing.

One embodiment is a method of displaying item lists and item views for a product assembly process. The method includes storing item data and visualization data, displaying the item data, receiving a first user input that selects a subset of the item data, receiving a second user input that selects a viewing mode, and, in response to a third user input, reading a subset of the visualization data that corresponds to the first user input and displaying the subset of the visualization data according to the viewing mode. In this manner, downloading time and display processing time is saved as compared to other systems.

The method may further include receiving a fifth user input that selects a second subset of the item data that overlaps the subset of the item data, reading a second subset of the visualization data that excludes the subset of the visualization data, and displaying the second subset of the visualization data. A download time or a processing time is saved as compared to reading a third subset of the item data that includes the subset of the item data and the second subset of the item data.

The viewing mode may be one of a number of viewing modes, including a show planning relevant items viewing mode, an assigned items viewing mode, a planned assignments viewing mode, a selected product structure items viewing mode, and a routing operations viewing mode.

The routing operation may describe a single step in an assembly process for the product. Sequence data, which relates a plurality of routing operations in a sequence, may be stored.

A computer system may operate to implement the method described above. The computer system may store, execute or be otherwise controlled by one or more computer programs that control the computer system to implement the method described above.

A non-transitory computer readable medium may store instructions to control a computer system to perform the method described above. The instructions may include a data storage component and a planning client component. These components may control a computer system to perform the method described above.

The following detailed description and accompanying drawings provide a better understanding of the nature and advantages of the present invention.

### BRIEF DESCRIPTION OF THE DRAWINGS

FIG. 1 is a block diagram of a data processing system.

FIG. 2 is a graphical representation of an example user interface screen displayed by the planning client.

FIG. 3 is an example of an item list that shows a list of items.

FIG. 4 is a flowchart of a method 400 of displaying item lists and item views for a product assembly process.

FIG. 5 is a block diagram of an example computer system and network for implementing embodiments of the present invention.

### DETAILED DESCRIPTION

Described herein are techniques for controlling access in a computer system. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. A second step is required to follow a first step only when the first step must be completed before the second step is begun. Such a situation will be specifically pointed out when not clear from the context. A particular step may be omitted; a particular step is required only when its omission would materially impact another step.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, various computer-implemented methods, processes and procedures are described. It is to be understood that the various actions (receiving, storing, sending, communicating, displaying, etc.) are performed by a hardware device, even if the action may be authorized, initiated or triggered by a user, or even if the hardware device is controlled by a computer program, software, firmware, etc. Further, it is to be understood that the hardware device is operating on data, even if the data may represent concepts or real-world objects, thus the explicit labeling as “data” as such is omitted. For example, when the hardware device is described as “storing a record”, it is to be understood that the hardware device is storing data that represents the record.

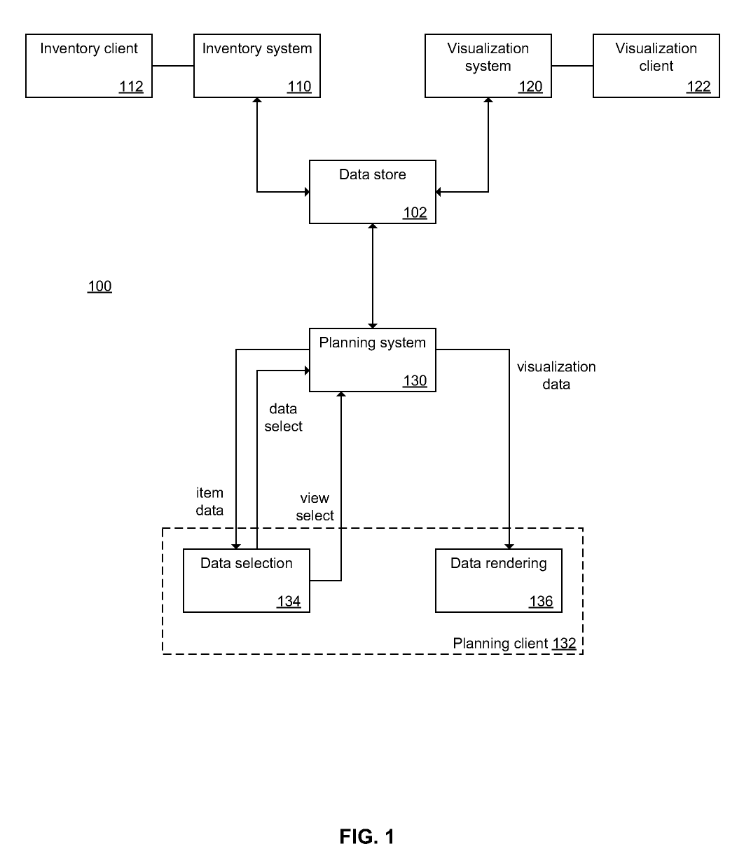

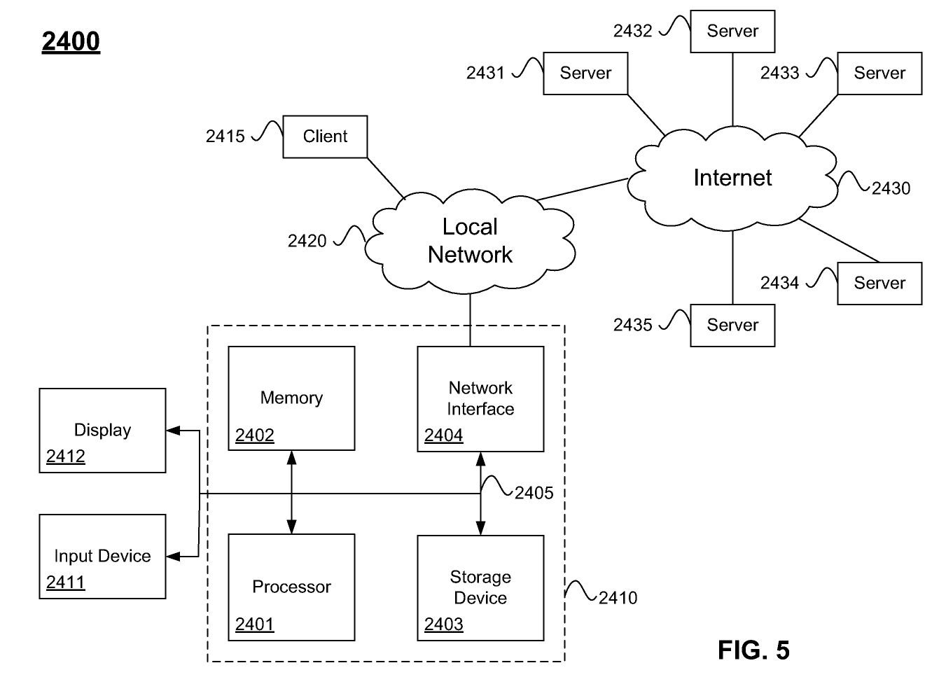

FIG. 1 is a block diagram of a data processing system 100. The data processing system 100 includes data storage 102, an inventory system 110, an inventory client 112, a visualization system 120, a visualization client 122, a planning system 130, and a planning client 132. These components may be connected via a network. These components may be implemented by one or more computing devices (see FIG. 5).

The data processing system 100 may be arranged according to a three tier architecture. The three tier architecture generally includes a database tier, an application tier, and a presentation tier. The database tier performs persistent storage of the data used by the data processing system 100. The database tier includes the data storage 102 (e.g., as implemented by one or more database servers). The application tier provides business logic for accessing or manipulating the data stored by the database tier. The application tier includes the inventory system 110, the visualization system 120, and the planning system 130 (e.g., as implemented by one or more application servers). The presentation tier provides a user interface for interacting with the application tier (and the associated data). The presentation tier includes the inventory client 112, the visualization client 122 and the planning client 132 (e.g., as implemented by one or more client computers).

The inventory system 110 operates on item data. The item data includes item lists, part lists, component lists, product lists, purchase orders, invoices, bills of material, etc. The inventory system 110 implements one or more applications that manipulate the item data, such as an invoicing application, a supply chain management application, etc. Examples of the inventory system 110 is an enterprise resource planning (ERP) system, a supply chain management (SCM) system, etc. Since the item data is mainly text data, the inventory client 112 may be a normal performance business type computer.

The visualization system 120 operates on visualization data. The visualization data includes three-dimensional (3D) data on items, parts, components, products, etc. Often the visualization data corresponds to the item data. For example, the item data includes a widget and the visualization data includes 3D data for the widget. Examples of the visualization system 120 include a computer aided design (CAD) system, a computer aided manufacturing (CAM) system, etc. Since the visualization data is mainly 3D data, the visualization client 122 is often required to be a high performance computer; a normal performance business type computer (such as that used for the inventory client 112) would often be insufficient.

The planning system 130 operates on both the item data and the visualization data to generate a routing. In general, the routing describes how to assemble the components into a final product. This process is described in more detail below.

Since the planning client 132 uses the 3D visualization data, in general it has the same type of performance requirements as the visualization client 122; however, embodiments of the present invention are directed to systems and methods of managing the amount of 3D data that is required at a given time, thus enabling the planning client 132 to be implemented with a more normal performance business type computer like the inventory client 112. The planning client 132 includes a data selection component 134 and a data rendering component 136. In general, the data selection component 134 requests a subset of the item data (“data select”) from the data store 102 that is relevant for creating a part of the routing; the data rendering component 136 receives and displays a corresponding subset of the visualization data according to a selected viewing mode (“view select”); thus the planning client 132 need not render all the 3D data related to the routing for the entire final product. This process is described in more detail below.

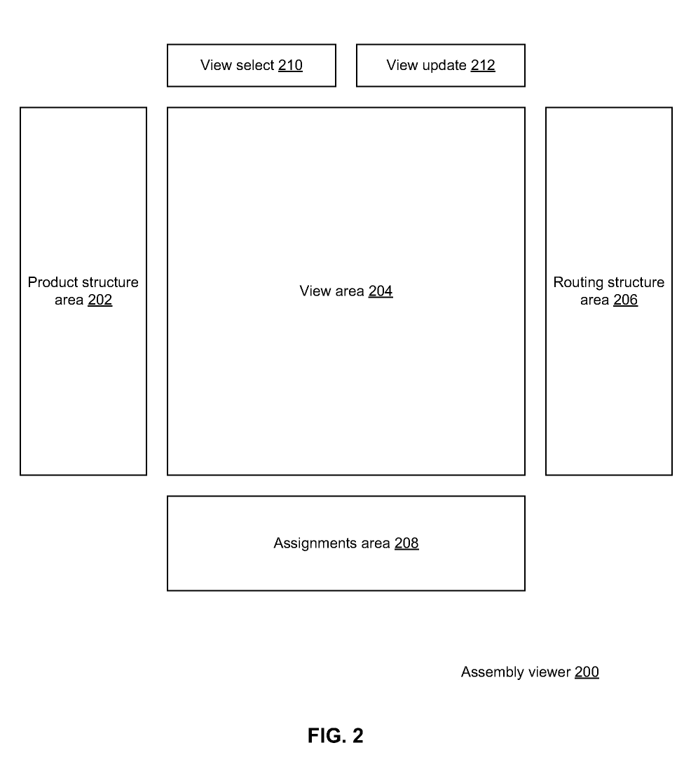

FIG. 2 is a graphical representation of an example user interface screen displayed by the planning client 132. This graphical representation may be referred to as the assembly viewer 200. The assembly viewer 200 includes a product structure area 202, a view area 204, a routing structure area 206, an assignments area 208, a view select area 210, and a view update area 212.

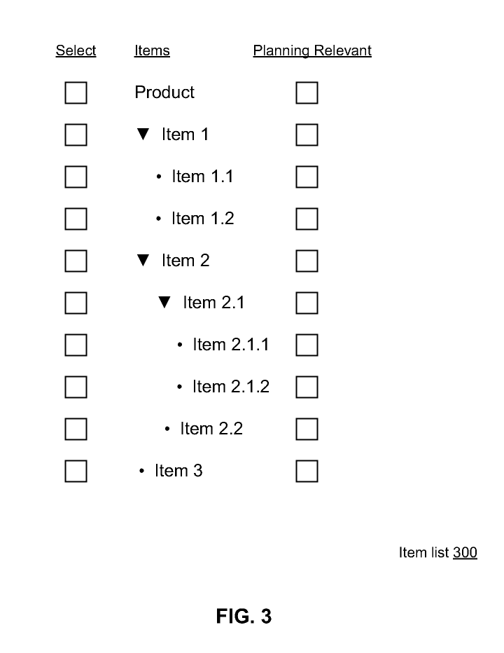

The product structure area 202 displays an item list 300, as shown in more detail in FIG. 3. The item list corresponds to a final product “Product” and its components (e.g., “Item 1”) for which a routing is to be generated. In FIG. 3, the item list 300 shows a list of items. The list of items corresponds to the final product and the components that need to be assembled to result in the final product. The items are grouped hierarchically at various levels of granularity. For the specific example shown, the Product is made from three items: Item 1, Item 2 and Item 3. Item 1 is itself made from two items, Item 1.1 and Item 1.2. Item 2 is also made from two items,

Item 2.1 and Item 2.2; Item 2.2 is itself made from two items, Item 2.1.1 and Item 2.1.2. The items with subitems (e.g., Item 1 has Items 1.1 and 1.2 as subitems) include a selection arrow to expand or collapse the subitem groups. (All groups are shown expanded in the item list 300.) The items also include two boxes, the “select” box and the “planning relevant” box. The select box allows the work scheduler to select one or more items for display in the “selected product structure items” viewing mode, as further described below. The planning relevant box is a check box that indicates whether the items are “planning relevant”, as further described below.

Returning to FIG. 2, the view area 204 displays 3D visualizations of the selected items listed in the product structure area 202. For example, a product is composed of five items; the first step in generating the routing involves only Item 1 and Item 2, so those are the only items that need to be selected (via the select boxes in the item list 300) and displayed (in the view area 204). The second step in generating the routing involves only Item 2 and Item 3; the visualization data for Item 2 does not need to be downloaded, since it was already downloaded for generating the first step. Thus, network bandwidth is saved in the second step. In addition, graphics processing time is saved in both steps, since only Items 1 and 2 need to be rendered for the first step, and only Items 2 and 3 need to be rendered for the next step. The features of the view area 204 may vary according to the technology used to implement the view area 204. As further described below, the view area 204 may be implemented as a plugin to one or more selected visualization software tools.

The routing structure area 206 displays a list of the defined steps in the assembly process. Each defined step includes a reference to the items assembled in that step and instructions relating to the assembly process. For example, Step 1 is to connect Item 1.1 and Item 1.2 to form Item 1; Step 2 is to connect Item 2.1 and Item 2.2 to form Item 2; etc. Each defined step also includes a select box (similar to that described above for the item list 300 of FIG. 3) that may be used to visualize those items, as further described below with reference to the “show routing operations” mode.

The assignments area 208 displays the linkages between the geometric instances of a product structure item and a routing operation. By deleting such a link, the assignment of a product structure item to a routing operation is undone. Furthermore, information regarding the product structure item (e.g., assigned material, change the number with which it was created/changed) and the routing operation (e.g., change the number with which it was created/changed) are displayed here.

The view select area 210 allows for user input of a viewing mode. According to an embodiment, the viewing modes include to show planning relevant items, assigned items, planned assignments, selected product structure items, and routing operations.

The planning relevant items are those that the work scheduler has selected to create the steps in the assembly process. The work scheduler selects the relevant items using the check boxes in the item list 300 (see FIG. 3) at the appropriate level of granularity. For example, Item 1 has two components, Items 1.1 and 1.2. If Item 1 is purchased already assembled, then the work scheduler selects the “planning relevant” box for Item 1 in the item list 300. If instead Item 1 is to be assembled from its components, then the work scheduler selects the “planning relevant” boxes for Items 1.1 and 1.2. In general, viewing the planning relevant items results in the display of the final, assembled product.

The assigned items are those that have been assigned to a step in the assembly process. This view allows the work scheduler to see the overall progress made in defining the assembly process. For example, once the work scheduler has defined the step for assembling Items 1 and 2, Items 1 and 2 become “assigned items” and may be viewed as such in the view area 204. As the work scheduler continues the creation of the steps in the assembly process, the work scheduler can view the “assigned items” to visualize the progression of the overall assembly process toward the final, assembled product.

The planned assignments are those items that have not yet been assigned to a step in the assembly process. This view allows the work scheduler to see the items that are relevant to steps in the assembly process that still need to be defined. Initially, the “planned assignments” correspond to the “planning relevant items”; as more steps in the assembly process are defined, the planned assignments become fewer and fewer.

The selected product structure items are those that have been selected in the item list 300 (see FIG. 3) using the “select” box. This view is useful to show items independently of any assignments or planning-relevant scope, just to see what the selected item looks like. The work scheduler may use this mode initially to identify items that are to be subsequently selected as planning-relevant items. For example, if the items are End Plate 1, End Plate 2, Coupling 1, Coupling 2, and Connector, the work scheduler may view Coupling 1 and Coupling 2 as selected product structure items to see which of those connects to the End Plate 1. Once the work planning process is underway, this view enables the work scheduler to confine the 3D data displayed in the view area 204 to the items that are relevant for defining each current step in the assembly process. After each step has been defined, the work scheduler can select other items in the item list 300 for display in the view area 204 to create the next step in the assembly process, etc. Using this view (in combination with the view update area 212) enables the savings of bandwidth and display processing time discussed above.

The routing operations view shows the items involved in one (or more) assembly steps, as selected in the routing structure area 206. This view is useful to show the results of a particular assembly step. Using this view (in combination with the view update area 212) also enables the savings of bandwidth and display processing time. For example, if the work scheduler has defined Step 1 for assembling Items 1 and 2 in the previous step, and has defined Step 2 for assembling Items 3 and 4 in the current step, then Items 3 and 4 have already been downloaded and rendered as part of creating the current step; when the work scheduler selects Steps 1 and 2 to display in the routing operations view, only Items 1 and 2 need to be downloaded and rendered.

More specifically, a goal of this viewing mode is that the work scheduler can step by step visualize the assembly process by first selecting the first routing operation, while only displaying the product items/parts that are needed in this operation. Then, he selects the next operation in addition to the already selected first one. Then the product items/parts that are needed in the second operations are displayed in the viewer in addition to the ones that were needed during the first operation. If he continues this process, he sees step by step how the assembled product grows and verifies the process step by step.

The view update area 212 allows for user input to instruct the planning client 132 to request the selected subset of the visualization data from the data store 102 (see FIG. 1). The view update area 212 may be implemented by a button that the user clicks using a mouse. More specifically, downloading and rendering the visualization data does not occur dynamically, but is triggered by user selection of the view update area 212. This saves bandwidth and display processing time since often the work scheduler will be selecting and de-selecting various items for potential display, and has no need to dynamically view items that may be de-selected.

The following paragraphs provide an elaboration of the interaction between the various items in the assembly viewer 200.

As discussed above, the product structure area 202 shows the item list 300 (see FIG. 3), also referred to as the product structure. A product structure consists of several items which are the parts the final product consists of. In order to assemble the final product these parts have to be assembled in a certain order. A routing documents how to assemble a product, which means it comprises the assembly process for creating the final product. Routings are divided into operations and sequences. A routing operation defines a single step in the assembly process, whereas a sequence groups several operations together defining in which order the routing operations have to be processed.

The items of a product structure are listed hierarchically and can have a different granularity. That means that such an item can be an assembly or a single material. For example, a robot arm is the assembly item; it consists of an ulna, an elbow, and an elbow extension. The business can decide either to buy the complete robot arm or to assemble the robot arm from purchased components. When the complete arm has been bought, the work scheduler marks the complete arm as “planning-relevant instance” (as this arm has to be assigned to an operation in order to assemble the robot). When the components are purchased, the work scheduler plans the assembling of the arm itself by marking its subcomponents (ulna, elbow, elbow extension) as “planning-relevant” items in order to assign them to routing operations in which they are assembled together, creating the robot arm (which itself may be an intermediate step in assembling with other components in another routing operation in order to create a robot).

So, a planning-relevant item is a part of the product structure that the work scheduler wants to assign to a routing operation. As shown in FIG. 3, the work scheduler may denote the planning relevant items by checking the “planning relevant” box.

That means that all planning-relevant items of a product structure define the “work list” for a work scheduler. The work list is usually a subset of the complete product structure. As long as an item is not linked to a routing operation, all planning-relevant items are also “planned items”. By assigning one of these items to a routing operation this item is turned into an assigned item. That means the number of “planning-relevant items” minus the number of “assigned items” defines the number of “planned items” the work scheduler still has to take into account for the remaining assembling process in order to define in which routing operation this item is used.

The “assigned items view” is a list of all assigned items. The viewer mode/display option to show assigned items represents this list visually. The viewer mode/display option to show routing operations is used to select a certain routing operations and to see in the viewer which product items are assigned to this operation and have to be assembled during this operation.

The mode “show selected product structure items” just displays all items in the view area 204, which are marked in the product structure area 202. This mode can be used independently from any assignments or planning-relevant scope just in order to see how the item looks like. It can be helpful to use this mode to define the planning-relevant items, as the visualization helps to find out what a concrete item in the product structure actually is.

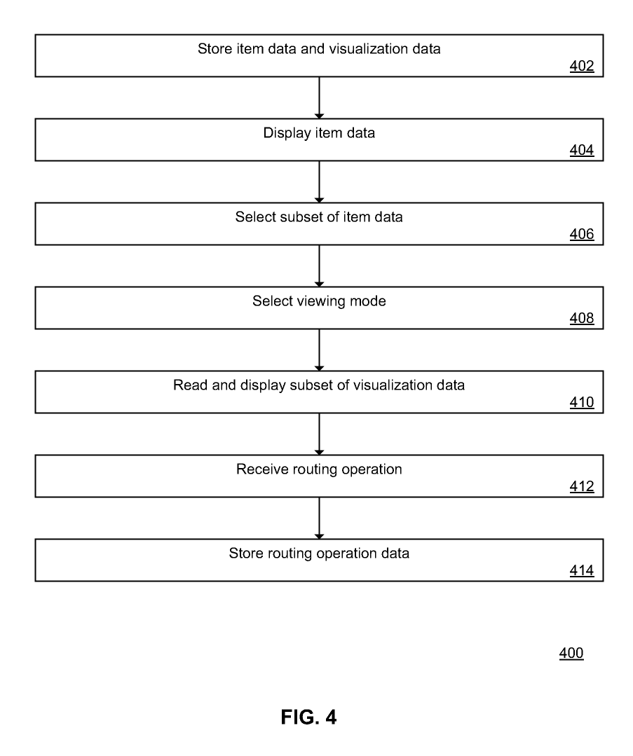

FIG. 4 is a flowchart of a method 400 of displaying item lists and item views for a product assembly process. The method 400 generally describes the operation of a data processing system (e.g., the data processing system 100 of FIG. 1) including a planning computer (e.g., the planning client 132) when a planner is creating the routing for the product assembly process. The data processing system may also include other devices for data storage, data retrieval, data input, or data output. For example, the planning computer 132 uses the data store 102 to store various data.

At 402, the data processing system stores the item data and the visualization data. For example, the data processing system 100 (see FIG. 1) works with the inventory system 110 to manage the item data, and works with the visualization system 120 to manage the visualization data. As discussed above, the item data corresponds to items that are components of one or more products to be assembled, and the visualization data corresponds to 3D visualizations of the items.

At 404, the data processing system displays the item data. For example, the work scheduler may use the planning client 132 to log on to the planning system 130 and to request a bill of materials from the data store 102 for a particular product for which the work scheduler desires to generate a routing. The data store 102 may store a variety of bills of materials or product lists, in which case the work scheduler may select one or more of them. For example, the planning client 132 includes the data selection component 134 as part of its user interface; the data selection component 134 receives the “item data” (see FIG. 1) from the data store 102 for display.

At 406, the data processing system receives a user input that selects a subset of the item data. For example, the planning client 132 displays the item list 300 (see FIG. 3), some of which may be checked as “planning relevant”. The work scheduler may modify the status of the various items as “planning relevant”. The work scheduler then begins planning the assembly process. In order to visualize the various components of the product, the work scheduler selects a subset of the items for subsequent display. For example, the planning client 132 includes the data selection component 134 as part of its user interface; the data selection component 134 sends the selected subset of items as the “data select” in FIG. 1.

At 408, the data processing system receives a user input that selects a viewing mode. For example, the view select area 210 (see FIG. 2) may contain a drop down list of available viewing modes, and the work scheduler selects one. In planning the assembly process, the work scheduler will often select the “show selected product structure items” display mode in order to view the items selected in 406. The work scheduler may then select the other viewing modes as appropriate as the work scheduler continues planning the assembly process. For example, the planning client 132 includes the data selection component 134 as part of its user interface; the data selection component 134 provides the “view select” information (see FIG. 1) to the data rendering component 136.

At 410, in response to a user input, the data processing system reads a subset of the visualization data that corresponds to the user input (from 406) and displays the subset of the visualization data according to the viewing mode (from 408). For example, the work scheduler presses the view update button 212 via the user interface of the planning client 132, which instructs the planning system 130 to read the visualization data from the data store 102 that corresponds to the items the work scheduler wishes to view (see 406). The planning client 132 then displays this subset of the visualization data in the selected viewing mode (see 408). For example, the planning client 132 includes the data rendering component 136 that renders and displays the “visualization data” from the data store 102. As discussed above, the use of the view update button 212 results in savings of bandwidth and display processing time.

At 412, the data processing system receives a user input that corresponds to a routing operation. The routing operation relates to assembling at least two of the items. For example, the work scheduler uses the user interface of the planning client 132 to enter routing information into the assignments area 208 (see FIG. 2). The work planner decides whether the sequences can be performed in parallel or not, gives it a description and can define a branch operation and returning operation for alternative sequences. Furthermore, lot size information and alignment key information (used for termination purposes) can be given. The single steps of a sequence, so-called operations, define information about how the work step has to be controlled (control key—e.g. no control, with inspection, with automatic goods receipt), in which plant and on which work center it has to be performed, and can have assigned product resource tools which are used (or needed) in order to perform the assembling.

At 414, the data processing system stores routing operation data that represents the routing operation. For example, the data store 102 stores the routing operation data. The planning client 132 may display the routing operations in the routing structure area 206 and the assignments area 208. The routing structure area 206 may be used to display the full details, and the assignments area 208 may be used to display key information.

The work scheduler may then perform various of the steps above to generate the rest of the routing. Often this will involve using the “show planning relevant items” viewing mode to show the entire planning scope, the “assigned items” viewing mode to show the progress made in the planning process, the “planned assignments” viewing mode to show the extent of remaining planning that needs to be performed, the “selected product structure items” viewing mode to identify items to generate a routing between, and the “routing operations” viewing mode to view the results of routing steps. As each step in the routing is planned, the sequence of steps may be stored with the rest of the routing operation data in the data store 102.

As discussed above, the use of the view update button 212 results in savings of bandwidth and display processing time as the work scheduler is planning the assembly process. For example, using the item list 300 (see FIG. 3), assume as a first step that the work scheduler has planned the routing for assembling Items 1.1 and 1.2 into Item 1. The work scheduler then wants to plan the routing for connecting Item 1 to Item 2. Since Item 1 is currently being displayed, the planning client 132 only needs to download and render the visualization data for Item 2. This results in saving the bandwidth involved in downloading the visualization data for Item 1 again, and saving processing time in rendering the visualization data for Item 1 again.

The view area 204 may be implemented using a plugin that displays the downloaded visualization data in accordance with the features of the plugin. For example, an embodiment implements 3D visualization software from Right Hemisphere, Inc. (recently acquired by SAP AG). Once the visualization data has been downloaded to the planning client 132 (in accordance with the view select area 210 and the view update button 212), the work scheduler may use the features of the plugin to view the visualization data. Example features include view manipulation (tilt, pan, scroll, zoom, pullback, rotate, pull apart, reassemble, wireframe, etc.), selecting components, hiding components, shading components, viewing cross-sections, making components transparent, etc. Since the desired data has already been downloaded, no additional network bandwidth is required to use the features of the plugin. In addition, processing time is saved because the plugin is not required to render visualization data that the work scheduler has not selected.

FIG. 5 is a block diagram of an example computer system and network 2400 for implementing embodiments of the present invention. Computer system 2410 includes a bus 2405 or other communication mechanism for communicating information, and a processor 2401 coupled with bus 2405 for processing information. Computer system 2410 also includes a memory 2402 coupled to bus 2405 for storing information and instructions to be executed by processor 2401, including information and instructions for performing the techniques described above. This memory may also be used for storing temporary variables or other intermediate information during execution of instructions to be executed by processor 2401. Possible implementations of this memory may be, but are not limited to, random access memory (RAM), read only memory (ROM) (when not storing temporary variables or other intermediate information), or both. A storage device 2403 is also provided for storing information and instructions. Common forms of storage devices include, for example, a hard drive, a magnetic disk, an optical disk, a CD-ROM, a DVD, a flash memory, a USB memory card, a solid state drive, or any other medium from which a computer can read. Storage device 2403 may store source code, binary code, or software files for performing the techniques or embodying the constructs above, for example.

Computer system 2410 may be coupled via bus 2405 to a display 2412, such as a cathode ray tube (CRT) or liquid crystal display (LCD), for displaying information to a computer user. An input device 2411 such as a keyboard and/or mouse is coupled to bus 2405 for communicating information and command selections from the user to processor 2401. The combination of these components allows the user to communicate with the system. In some systems, bus 2405 may be divided into multiple specialized buses.

Computer system 2410 also includes a network interface 2404 coupled with bus 2405. Network interface 2404 may provide two-way data communication between computer system 2410 and the local network 2420. The network interface 2404 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 2404 sends and receives electrical, electromagnetic, or optical signals that carry digital data streams representing various types of information.

Computer system 2410 can send and receive information, including messages or other interface actions, through the network interface 2404 to an Intranet or the Internet 2430. In the Internet example, software components or services may reside on multiple different computer systems 2410 or servers 2431, 2432, 2433, 2434 and 2435 across the network. A server 2431 may transmit actions or messages from one component, through Internet 2430, local network 2420, and network interface 2404 to a component on computer system 2410.

The computer system and network 2400 may be configured in a client server manner. For example, the computer system 2410 may implement a server. The client 2415 may include components similar to those of the computer system 2410.

More specifically, as described above, the computer system 2410 may implement the planning client 132. The server 2431 may implement the inventory system 110, the server 2432 may implement the visualization system 120, and the server 2433 may implement the planning system 130. Alternatively, the server 2434 may implement the inventory system 110, the visualization system 120, and the planning system 130, for example as applications that operated in an integrated application environment (e.g., and ERP application, a CAD/CAM application, etc.) The server 2435 may implement the data store 102 (e.g., using a database system). The client 2415 may implement the inventory client 112, and a high performance client (not shown) may implement the visualization client 122.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method of displaying item lists and item views for a product assembly process, comprising:
storing item data and visualization data, wherein the item data corresponds to a plurality of items, wherein the plurality of items corresponds to a product to be assembled, and wherein the visualization data corresponds to a plurality of visualizations of the plurality of items;
displaying the item data;
receiving a first user input that selects a subset of the item data;
receiving a second user input that selects a viewing mode;
in response to a third user input, reading a subset of the visualization data that corresponds to the first user input and displaying the subset of the visualization data according to the viewing mode;
receiving a fourth user input that corresponds to a routing operation, wherein the routing operation relates to assembling at least two of the plurality of items; and
storing routing operation data that represents the routing operation.

2. The computer-implemented method of claim 1, further comprising:
receiving a fifth user input that selects a second subset of the item data that overlaps the subset of the item data;
reading a second subset of the visualization data that excludes the subset of the visualization data; and
displaying the second subset of the visualization data,
wherein a download time is saved as compared to reading a third subset of the item data that includes the subset of the item data and the second subset of the item data.

3. The computer-implemented method of claim 1, further comprising:
receiving a fifth user input that selects a second subset of the item data that overlaps the subset of the item data;
reading a second subset of the visualization data that excludes the subset of the visualization data; and
displaying the second subset of the visualization data,
wherein a processing time is saved as compared to displaying a third subset of the visualization data that includes the subset of the visualization data and the second subset of the visualization data.

4. The computer-implemented method of claim 1, wherein the viewing mode is one of a plurality of viewing modes.

5. The computer-implemented method of claim 1, wherein the viewing mode is one of a plurality of viewing modes, wherein the plurality of viewing modes includes a show planning relevant items viewing mode, an assigned items viewing mode, a planned assignments viewing mode, a selected product structure items viewing mode, and a routing operations viewing mode.

6. The computer-implemented method of claim 1, wherein the routing operation describes a single step in an assembly process for the product.

7. The computer-implemented method of claim 1, further comprising:
storing sequence data that relates a plurality of routing operations in a sequence.

8. A system for displaying item lists and item views for a product assembly process, comprising:
a data storage system that is configured to store item data and visualization data, wherein the item data corresponds to a plurality of items, wherein the plurality of items corresponds to a product to be assembled, and wherein the visualization data corresponds to a plurality of visualizations of the plurality of items; and
a planning client computer that is configured to display the item data, to receive a first user input that selects a subset of the item data, and to receive a second user input that selects a viewing mode,
wherein in response to a third user input, the planning client computer is configured to read a subset of the visualization data that corresponds to the first user input and to display the subset of the visualization data according to the viewing mode,
wherein the planning client computer is configured to receive a fourth user input that corresponds to a routing operation, wherein the routing operation relates to assembling at least two of the plurality of items, and
wherein the data storage system is configured to store routing operation data that represents the routing operation.

9. The system of claim 8, wherein the planning client computer is configured to receive a fifth user input that selects a second subset of the item data that overlaps the subset of the item data;
wherein the planning client computer is configured to read a second subset of the visualization data that excludes the subset of the visualization data;
wherein the planning client computer is configured to display the second subset of the visualization data; and
wherein a download time is saved as compared to reading a third subset of the item data that includes the subset of the item data and the second subset of the item data.

10. The system of claim 8, wherein the planning client computer is configured to receive a fifth user input that selects a second subset of the item data that overlaps the subset of the item data;
wherein the planning client computer is configured to read a second subset of the visualization data that excludes the subset of the visualization data;
wherein the planning client computer is configured to display the second subset of the visualization data; and
wherein a processing time is saved as compared to displaying a third subset of the visualization data that includes the subset of the visualization data and the second subset of the visualization data.

11. The system of claim 8, wherein the viewing mode is one of a plurality of viewing modes.

12. The system of claim 8, wherein the viewing mode is one of a plurality of viewing modes, wherein the plurality of viewing modes includes a show planning relevant items viewing mode, an assigned items viewing mode, a planned assignments viewing mode, a selected product structure items viewing mode, and a routing operations viewing mode.

13. The system of claim 8, wherein the routing operation describes a single step in an assembly process for the product.

14. The system of claim 8, wherein the data storage system is configured to store sequence data that relates a plurality of routing operations in a sequence.

15. A non-transitory computer readable medium storing instructions to control a computer system for displaying item lists and item views for a product assembly process, comprising:
a data storage component that is configured to control a data storage system to store item data and visualization data, wherein the item data corresponds to a plurality of items, wherein the plurality of items corresponds to a product to be assembled, and wherein the visualization data corresponds to a plurality of visualizations of the plurality of items; and
a planning client component that is configured to control a planning client computer to display the item data, to receive a first user input that selects a subset of the item data, and to receive a second user input that selects a viewing mode,
wherein in response to a third user input, the planning client component is configured to control the planning client computer to read a subset of the visualization data that corresponds to the first user input and to display the subset of the visualization data according to the viewing mode,
wherein the planning client component is configured to control the planning client computer to receive a fourth user input that corresponds to a routing operation, wherein the routing operation relates to assembling at least two of the plurality of items, and
wherein the data storage component that is configured to control the data storage system to store routing operation data that represents the routing operation.

16. The computer readable medium of claim 15, wherein the planning client component is configured to control the planning client computer to receive a fifth user input that selects a second subset of the item data that overlaps the subset of the item data;
wherein the planning client component is configured to control the planning client computer to read a second subset of the visualization data that excludes the subset of the visualization data;
wherein the planning client component is configured to control the planning client computer to display the second subset of the visualization data; and
wherein a download time is saved as compared to reading a third subset of the item data that includes the subset of the item data and the second subset of the item data.

17. The computer readable medium of claim 15, wherein the planning client component is configured to control the planning client computer to receive a fifth user input that selects a second subset of the item data that overlaps the subset of the item data;
wherein the planning client component is configured to control the planning client computer to read a second subset of the visualization data that excludes the subset of the visualization data;
wherein the planning client component is configured to control the planning client computer to display the second subset of the visualization data; and
wherein a processing time is saved as compared to displaying a third subset of the visualization data that includes the subset of the visualization data and the second subset of the visualization data.

18. The computer readable medium of claim 15, wherein the viewing mode is one of a plurality of viewing modes, wherein the plurality of viewing modes includes a show planning relevant items viewing mode, an assigned items viewing mode, a planned assignments viewing mode, a selected product structure items viewing mode, and a routing operations viewing mode.

19. The computer readable medium of claim 15, wherein the routing operation describes a single step in an assembly process for the product.

20. The computer readable medium of claim 15, wherein the data storage system is configured to store sequence data that relates a plurality of routing operations in a sequence.
